(19) United States
(12) Patent Application Publication
(10) Pub. No.: US 2023/0410615 A1
(43) Pub. Date: Dec. 21, 2023

(54) SYSTEM INTEGRATING DISPARATE EMERGENCY DETECTION AND RESPONSE CAPABILITIES

(71) Applicant: Daniel Rodriguez, Lake Worth, FL (US)

(72) Inventor: Daniel Rodriguez, Lake Worth, FL (US)

(21) Appl. No.: 18/239,944

(22) Filed: Aug. 30, 2023

Related U.S. Application Data
(63) Continuation of application No. 16/745,928, filed on Jan. 17, 2020, now abandoned.
(60) Provisional application No. 62/816,527, filed on Mar. 11, 2019.

(51) Int. Cl. G08B 7/06; G08B 25/00; G08B 21/02; G01C 21/20

(52) U.S. Cl. CPC G08B 7/066; G08B 7/062; G08B 25/009; G08B 21/02; G01C 21/206

(57) ABSTRACT

A system integrating disparate emergency response capabilities within a facility including a sensor assembly comprising a plurality of sensors disposed in predetermined locations throughout the facility, wherein different ones of said plurality of sensors are determinative of different emergency conditions such as, but not limited to, fire, smoke, active shooter emergencies, etc. A display assembly comprises a plurality of displays located in different facility areas (rooms, offices, stores, etc.) as well as along pathways, defining escape routes, between each of the plurality of facility areas and an appropriate facility exit. A database, including software programing is responsive to said sensor assembly and operative to generate messaging to said plurality of displays, wherein the messaging includes variable responsive content, including evacuation mapping or lockdown instructions, dependent on detected emergency conditions (fire, active shooter, etc.).

### CLAIM OF PRIORITY

The present application is a Continuation patent application of and claims priority to a previously filed, U.S. Non-Provisional patent application, namely, that having Ser. No. 16/745,928 and a filing date of Jan. 17, 2020, and further, claims priority pursuant to 35 U.S.C. Section 119(e) to a previously filed, U.S. Provisional patent application, namely, that having Ser. No. 62/816,527 and a filing date of Mar. 11, 2019, with the contents of both prior applications being incorporated herein by reference in their entireties.

### BACKGROUND OF THE INVENTION

### Field of the Invention

The present invention is directed to a system utilizing software and artificial intelligence to integrate normally disparate emergency detection and response capabilities, thereby enabling the implementation of real-time evacuation routing and/or lockdown instructions, via a plurality of smart displays, based on emergency detection by a plurality of sensors within a given facility.

### Description of the Related Art

Emergency situations often require immediate implementation of appropriate responsive procedures in order to restrict or eliminate loss of human life and/or injuries. Naturally, different types of emergencies including, but not limited to, fire, weather conditions, active-shooter or like invasion situations, etc. require different responses. However, the mitigation of damage to individuals and/or facilities necessitates immediate or quick determination of such emergency conditions and equally efficient, facilitated responses thereto.

In recent years there has been an increase in the events of active-shooter situations in schools, churches, workplaces, commercial environments and other facility locations. Similar to noninvasive emergencies, such as fire, weather conditions, etc. and immediate or rapid determination of an active shooter situation is known to reduce fatalities and injuries.

Known or conventional, prior art systems which attempt to deal with emergency response situations involve various types of surveillance and or monitoring by live personnel as well as remote monitoring devices. Problems and disadvantages associated with such known or conventional systems relate to the absence of responsible guidance of individuals in the vicinity of or otherwise associated with a given emergency situation. By way of example only, responsive planning to an emergency situation relating to the development of a destructive fire may be significantly different and therefore totally inadequate as a response plan intended to deal with severe weather conditions or more purposely, active shooter emergencies.

Further by way of example, depending on the category of emergency, monitoring centers or other like monitoring facilities may be operative to contact an off-site and/or remote emergency response organization such as the police department, fire department, etc. While possibly effective in certain situations, there is typically a prolonged time lapse between an occurrence and detection of a given emergency and active response thereto by remotely located responders. Further individuals located at a given site where emergency conditions occur are frequently not provided adequate or meaningful guidance in a timely manner in order to avoid damage, injury, etc.

Also, it has become apparent that direct communication with individuals involved in an emergency, at various locations, is frequently ineffective and may be severely restricted or limited by the communication skills of the emergency responders. Inherent in such direct communication is the assumption that all of the individuals involved in a given emergency situation have common language skills or abilities, do not suffer from hearing loss or other medical restrictions which would render communication with such individuals ineffective.

Further, the severity and/or category of the emergency itself may significantly impede the ability to communicate with emergency responders in order to describe and define the type of emergency, the physical and implementing properties of the facilities at which such emergencies occur and other information which would significantly aid in an efficient, adequate response to a given emergency.
1. Accordingly, there is a significant need in the area of emergency response systems for a solution which overcomes the disadvantages and problems of the type commonly recognized and continuously practiced in known or conventional prior art response solutions. Such an improved and proposed response system is to cooperatively integrate normally disparate emergency detection and response capabilities such as, but not limited to, fire response, active shooter response, etc. Further, an improved and proposed response system would automate the process of implementing communications, building, floor plans, lockdown instructions and or predetermined, specific and timely routing instructions. Moreover, implementation of the system including these beneficial attributes could be based on artificial intelligence algorithm operative with a smart display platform to guide individuals from various facility areas to exits or in the alternative automatically generate lockdown instructions to one or more facility areas (rooms, offices, stores, etc.) dependent on the category of emergency. Further, the proposed improved emergency response system would implement middleware software solutions to connect and integrate smart signage displays utilizing open system-based hardware and software, associated with facility management and physical access to the facility, fire safety standards and active shooter situations.

### SUMMARY OF THE INVENTION

The present invention is directed to a system for integrating normally disparate emergency response capabilities within any one of a plurality of different type facilities. As such, one or more preferred embodiments of the system, as described in greater detail hereinafter, provides a middleware software solution to connect and integrate a plurality of smart signage displays and x86 open systems-based hardware and software with building management, physical access, fire safety and active shooter capabilities.

The system of the present invention further integrates an enterprise digital signage systems API and monitors with smart sensors and physical control panels, possibly using a Rest API to drive messaging, content, display and overall automation. Further, a software program, based on physical or virtual triggers, such as fire alarm pull, push button, or virtual trigger, will automate the insertion of messaging and/or content onto the plurality of smart displays. Such messaging and content can be but are not limited to, evacuation mapping including escape routes with directional arrows (vector mapping) that point to or delineate life safety routes (escape routes) facility area lockdown instructions for dealing with detected emergencies within a given facility, of the type set forth above.

Accordingly, the system of the present invention utilizes software and artificial intelligence to integrate normally disparate capabilities, thereby enabling the implementation of real-time evacuation routing and/or lockdown instructions and possibly other notifications, based on response and/or detection by a plurality of sensors distributed strategically throughout a given facility.

In addition, a software program is operative to provide a solution that can send instructions to different facility areas (rooms) throughout a given facility, when lockdown is preferred over evacuation or vice versa. The system of the present invention also provides the ability to collect data regarding sensor activity, sensor status and smart display activity, status, scheduling, etc. This data may also be utilized to further correlate safety planners in simulating safety-related scenarios. Using appropriate algorithm, individuals can be automatically re-routed to other exits from any of a plurality of facility areas, based on the status of the sensors deployed throughout the facility and the type of emergency detected.

The combination of displaying, overlaying and integrating life safety floor plans, recommended evacuation routes, physical access system data and attributes, fire alarm sensor notifications or triggers, active shooter system notifications or triggers and other API capable life safety systems are combined to both display and use algorithm processing to provide recommended, safe escape routes including and/or lockdown instructions.

The system further includes a control center or control capabilities comprising database, memory capabilities, software/computer. By way of example, in order to facilitate meaningful response to different emergency situations, floor plans of a given facility may be downloaded therein facilitating the automated creation of a vector map or grid matrix. Algorithms, based on source and destination of an escape route associated with a given emergency response, calculate the distance therebetween avoiding or taking into consideration the presence of obstructions, which may be implemented into the downloaded floor plans. In addition, obstructions to be avoided may also include furniture, office equipment, etc. As such, the evacuation mapping including preferred escape routes take into consideration distance, including the avoidance of noted obstructions, between any one of a plurality of facility areas (rooms, offices, stores, etc.) and a preferred or appropriate exit from the facility.

One feature of the implementation of the system of the present invention is the utilization of algorithm to determine the status of sensors along a given escape route or path to the extent of determining whether a sensor and or plurality of sensors are active in detecting an emergency condition. If found active, a given path will be avoided and an auxiliary path or escape route will be calculated and displayed. Moreover, the plurality of sensors of a sensor assembly can be weighted so that some have higher impact than others. Further, the “impact radius” or detectable area of each sensor may be represented on a displayed evacuation mapping. Therefore, the system determines an active/inactive response of a given sensor, thereby facilitating the ability to get additional related information such as locations, diagnostics, sensor measurement values etc. Such values allow the determination of the impact of a given sensor can and should have in determination of evacuation mapping and resulting escape routes.

One or more preferred embodiments of the system of the present invention also facilitates a determination of how, where and when various types of communications, including off-site or remote communication to an appropriate first responder or other agency, facility, capability, etc. are accomplished. Receiving such communication, first responders will be able to engage or access the communication facilities of the system to provide real-time updates and notifications.

Therefore, the system of the present invention, including one or more preferred embodiments thereof, provide a solution to the problems and disadvantages in conventional emergency response systems. Such solutions involve automating a procedure for injecting communications, building and floor plans, lockdown instructions or evacuation mapping including predetermined or specific and timely escape routing instructions. Such automated processing is based on the artificial intelligence algorithm implemented by a smart display platform. As a result, the aforementioned smart display platform or assembly can include a plurality of smart displays located in each of the facility areas (rooms, offices, etc.) as well as in hallways or pathways to guide the evacuation of individuals from anyone and or all of the facility areas to an appropriate exit from the facility.

Moreover, first responders and staff are able to initiate an evacuation and the corresponding evacuation mapping and or instructional messaging at any time. In addition, smart video cameras may be located in operative association with an activated sensor thereby allowing a controller to pull the video feed from a given sensor associated camera for display and evaluation.

Yet additional features implemented in the system of the present invention will allow for lock controls throughout a given facility, specifically including the facility areas so as to perform a locking of a given door, entrance, etc. and/or the unlocking thereof, depending upon the location, category, etc. of the detected emergency by the plurality of sensors.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1A is a schematic representation of the system of the present invention.

FIG. 1B is a schematic representation of the system of the present invention.

FIG. 1C is a schematic representation of the system of the present invention.

FIG. 1D is a schematic representation of the system of the present invention.

FIG. 2 is a schematic presentation representing the integration of disparate emergency response capabilities which may be associated with different types of facilities.

FIG. 3A is a schematic representation of one variable responsive content of messaging dependent on detected emergency conditions in a given facility.

FIG. 3B is a schematic representation of one variable responsive content of messaging dependent on detected emergency conditions in a given facility.

FIG. 4 is a schematic representation of evacuation mapping indicative of at least one escape route based on detected emergency conditions.

FIG. 5 is a schematic representation of evacuation mapping indicative of a different escape route, from that represented in FIG. 4, based on detected emergency conditions.

FIG. 6 is a schematic representation of evacuation mapping indicative of yet a different escape route, from that represented in FIGS. 4 and 5, based on detected emergency conditions.

FIG. 7A is a schematic representation of a floor plan of a given facility indicative of sensor polling procedures.

FIG. 7B is a schematic representation of a floor plan of a given facility indicative of display polling procedures.

FIG. 8A is a schematic representation of an emergency condition associated with detection of an active shooter.

FIG. 8B is a detailed view in schematic form of an active shooter sensor/alert.

Like reference numerals refer to like parts throughout the several views of the drawings.

### DETAILED DESCRIPTION OF THE PREFERRED EMBODIMENT

As represented in the accompanying Figures, the present invention is directed to a system implemented by software and artificial intelligence to integrate normally disparate emergency response capabilities and provide real-time messaging to various areas within a facility, wherein the messaging comprises variable responsive content dependent on the different emergency conditions detected.

For purposes of clarity certain terminology will be used in describing the emergency response system of the present invention as it could apply to different categories of facilities. As used herein, the term “facility” is meant to include, but not be limited to, any one of a variety of different buildings or locations such as schools, churches businesses, commercial areas, shopping centers etc. or any location where individuals commonly gather. In association therewith, the term “facility area” is meant to include, but not be limited to, rooms, offices, stores, lobbies or other general gathering areas, etc. In cooperation therewith, the term “facility exit” is meant to refer to ingress/egress locations associated with a given facility.

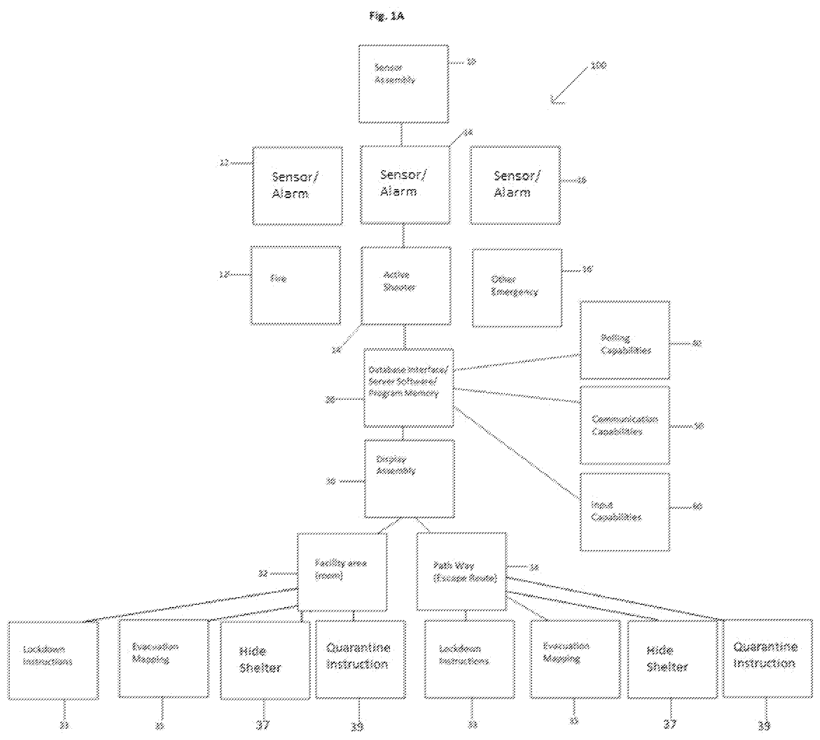

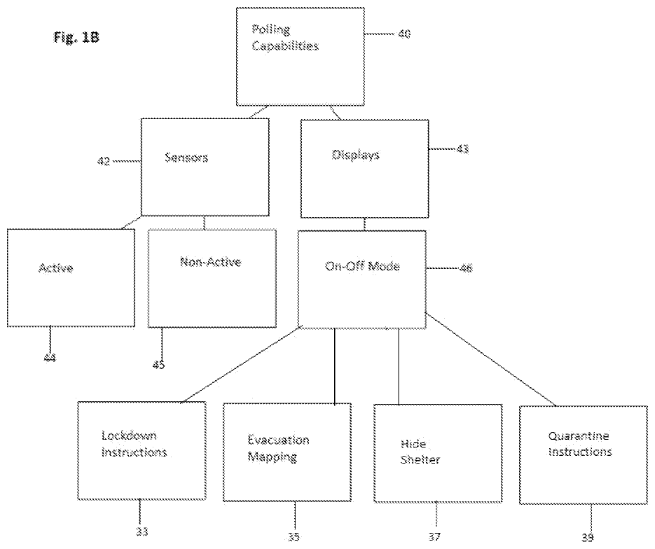

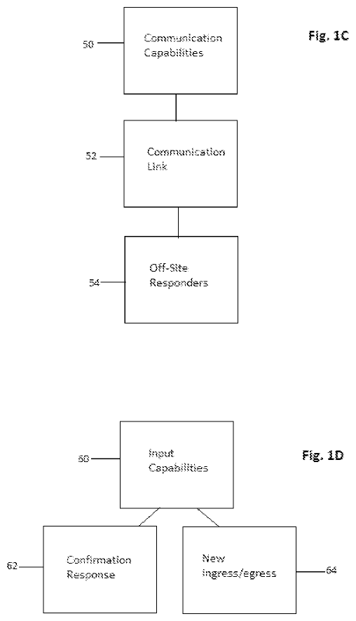

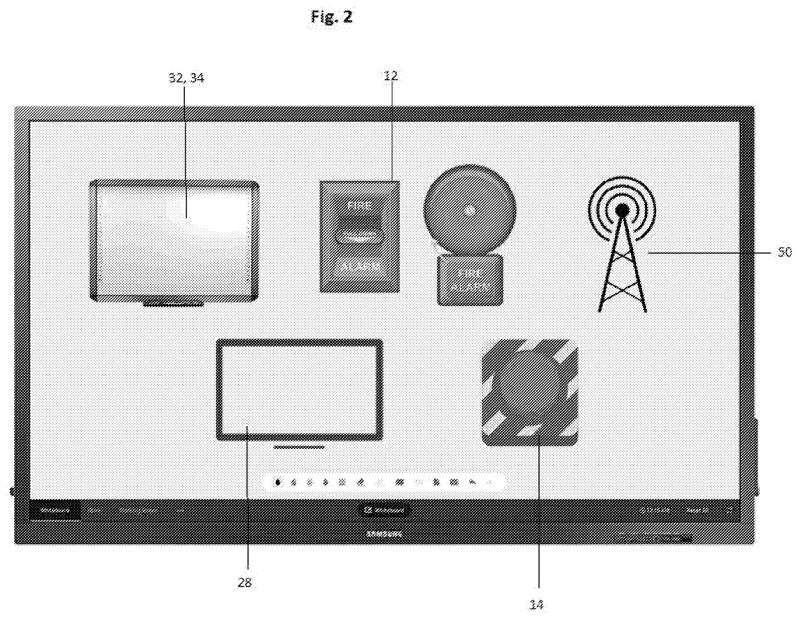

With initial reference to FIGS. 1A-1D and FIG. 2, a convergence of the normally disparate emergency response and detection capabilities and their implementation are presented. More specifically, a sensor assembly 10 comprising different sensors/alarms generally indicated as 12 associated with fire detection 12′. Other emergency response capabilities include physical security sensors/alarms 14 capable of detecting a shooter-active situation 14′ within a given facility 200. The system 100 of the present invention is not necessarily limited to sensors 12 and 14 for the detection of fire and active shooter situations. Accordingly, additional sensor/alarms 16 may be incorporated into the system 100 for the detection of other emergency situations, as at 16′. Communication capabilities 50 are also incorporated in the system 100 and facilitate communication both on-site and off-site for purposes of generating variably responsive messaging dependent on emergency conditions detected by the plurality of sensors 12, 14, 16, etc. As also represented, the system 100 of the present invention incorporates a display assembly 30 as well as different types of signage disposed throughout the facility 200 and a manner which is clearly accessible by individuals throughout the facility 200, especially when an emergency situation is detected.

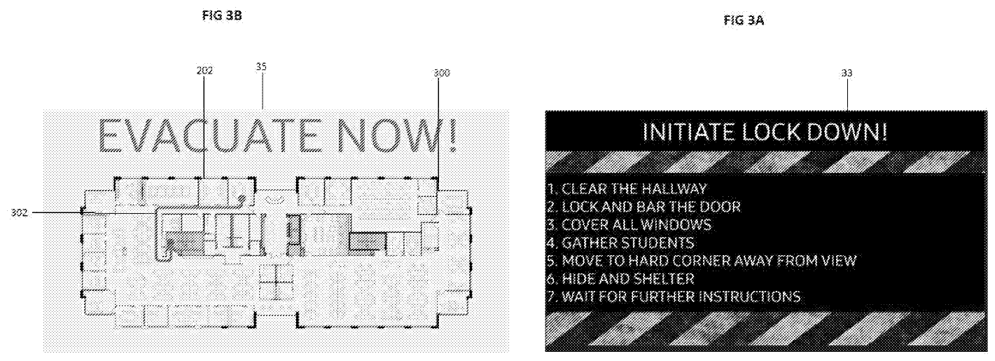

FIGS. 1A-1D collectively present a schematic representation of the system 100 of the present invention and its implementation in regards to anyone of a possible plurality of different facilities 200, a floor plan of which is schematically represented in FIGS. 3-7. As such, the system 100 of the present invention comprises the sensor assembly 10 comprising the plurality of sensors 12, 14, 16, etc. disposed in predetermined locations throughout the given facility 200. Strategic location of the plurality of sensors 12, 14, 16, etc. is such as to facilitate detection of a variety of emergency conditions such as, but not limited to, fire and/or smoke conditions 12′, active shooter conditions 14′ and possibly other emergency conditions, as at 16′.

The system 100 is implemented utilizing a control facility generally indicated as 20 including a database/interface server, operatively associated with software/program and memory/storage capabilities. Implementation of the system 100 is facilitated by software and artificial intelligence to integrate the normally disparate emergency detection and response capabilities as generally represented in FIG. 2 and in more detail throughout remaining FIGS. 1A-1C and 3-8B. Upon detection of one or more emergency conditions, the software/program is responsive to the sensor assembly 10 and operative to generate real-time messaging via a plurality of displays 32, 34 etc. as also indicated a plurality of displays of the display assembly 30 may be appropriately and strategically located throughout the facility 200. More specifically, a plurality of displays 32 may be located in each of the facility areas (rooms) wherein an additional plurality of displays 34 may be located throughout the hallways or pathways defining escape routes.

Operative communication between the sensor assembly 10 and the display assembly 30, via the control facilities 20 results in the generation of messaging. Moreover, the real time messaging comprises “variable responsive content” accessible on the plurality of displays 32 and 34, where in the displayed content is variable and responsive dependent on the different emergency conditions detected by the sensor assembly 10 and plurality sensors 12, 14, 16, etc.

Further, the variable responsive content of the generated messaging from the control facilities 20, may be automatically generated upon the detection of an emergency condition and may include, “lockdown instructions” 33; “evacuation mapping” 35; “hide and shelter instructions” 37 and/or quarantine instructions 39. As represented in FIG. 3A, the hide and shelter instructions 37 and the lockdown instructions 33 may include specific constructive messaging such as, but not limited to 1) Clear The Hallway; 2) Block And Bar The Door; 3) Cover All Windows; 4) Gather Students, (facility may be a school); 5) Move Away From View; 6) Hide And Shelter, and/or 7) Wait For Further Instructions.

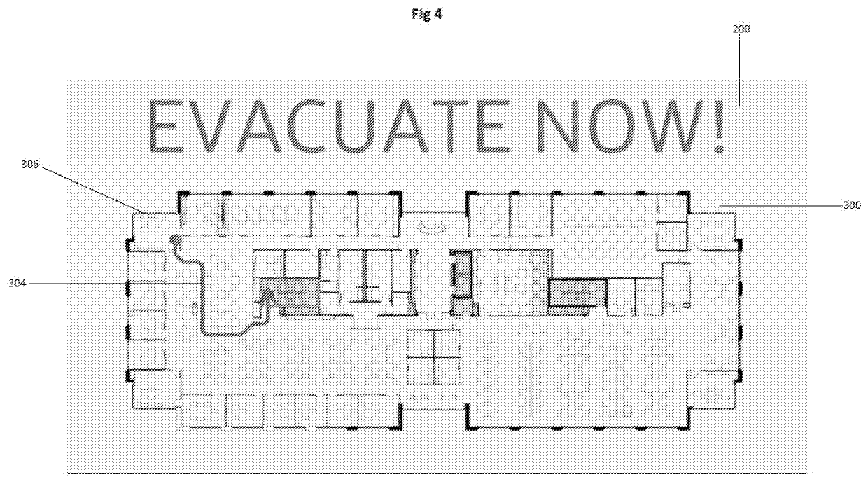

FIG. 3B represents a floor plan 300 of the facility 200 downloaded into the memory facilities of the control center 20. Again, dependent on the emergency detected by the sensor assembly 10, the evacuation mapping 35 may include a specific escape route 302 from a given facility area (room) 202 to a predetermined facility exit, as represented by the vector mapping or indicated safety path by directional arrows. Similarly, as represented in FIG. 4, a different evacuation mapping may be automatically generated representing a different escape route 304 from one or more different facility areas (rooms) 306.

As should be apparent, the plurality of displays 34 disposed and viewable within each of the plurality of facility areas (rooms, offices, etc.) as well as the displays 34 disposed within hallways, pathways, etc. may each display, both visually and audibly, the variable content messaging, in the form of lockdown instructions or evacuation mapping including escape routes as represented in FIGS. 3-6. It is to be further noted that the control facilities 20, including the software/program is operative to update the generated variable responsive content to include a change in the lockdown instructions or the evacuation mapping/escape route to the other of said lockdown instructions or escape routes.

More specifically, the plurality of sensors 12, 14, 16, etc. distributed throughout the facility 200 are continuously monitored/polled, schematically represented in FIG. 1B, to collectively provide a more accurate and complete representation of one or more emergency conditions and or a change in one or more emergency conditions. By way of example, if the emergency condition detected is in the form of an “active-shooter”, those facility areas located a safe distance from the detected shooter may be instructed to evacuate by evacuation mapping and escape routes delivered to a corresponding one of the plurality of displays associated with the remotely located facility areas. However, if the sensor assembly 10, including the plurality of sensors 12, 14, 16, etc. determine or detect movement of the active shooter to a different location, the initially remote facility areas may receive different responsive content such as “lockdown instructions”, as represented in FIG. 3. Such a change in the variable responsive content from the evacuation mapping/escape route format to the lockdown instructions format would be based on an automatic processing determination. Such automated processing would determine that any escape route from an initially remote facility area would no longer be safe based on movement or relocation of the active shooter. In such situations the generation and display of lockdown instructions would be more appropriate.

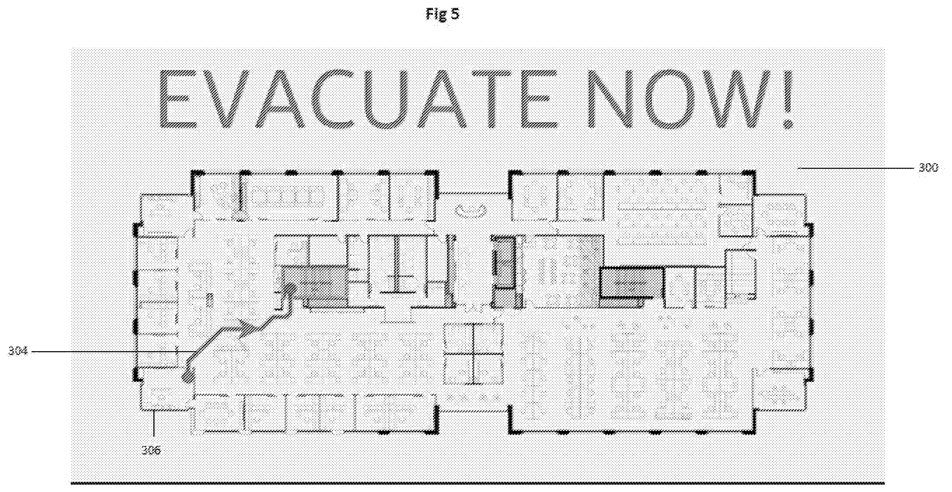

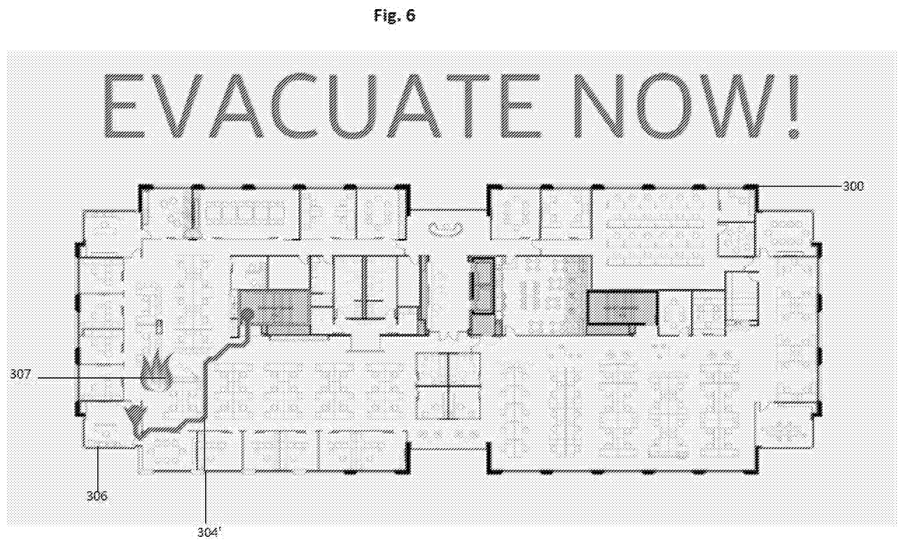

In addition to the above, the variable response content of the messaging may change, based on a change in a detected emergency condition or the development of an additional emergency condition. As schematically represented in FIG. 5, the floor plan 300 represents an escape route 304 from a facility area (room) 306 to a selected exit. However, as represented in FIG. 6, a detected emergency conditions, as at 307, may have recently developed or changed. Accordingly, such a newly developed emergency situation or change therein would result in the automated generation of a new escape route, as at 304′. The new escape route 304′ avoids the changed or newly developed emergency condition 307, in the form of a fire, while allowing occupants of the facility area 306 to reach the designated exit along a different escape route 304′ representing a safer path of travel.

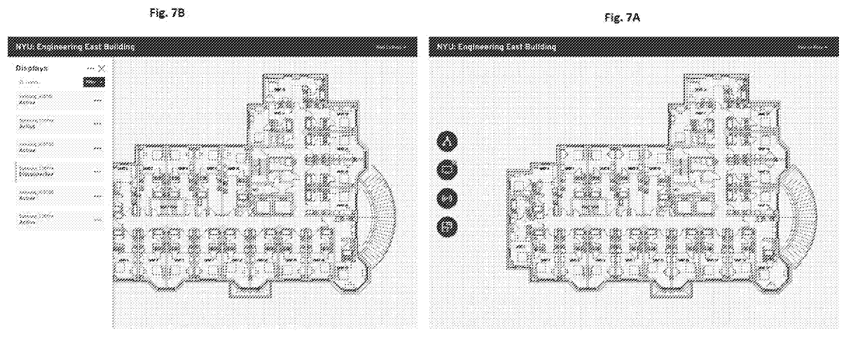

As set forth above, FIG. 1B is schematically representative of continuous polling 40 of the sensor assembly 10 (See FIG. 7A) and the display assembly 30 (See FIG. 7B). The continuous polling 40 includes a polling of the sensor assembly 10, as at 42. Such polling includes the plurality of sensors 12, 14, 16 etc. to determine a mode of operation as well as which if any of the plurality of sensors have been “activated”, as at 44. As used herein and activated sensor is meant to describe a sensor that has detected an emergency condition. In contrast, a “non-activated” sensor, as at 45 may be operable but has not detected an emergency condition.

Similarly, the plurality of displays 32, 34 of the display 30 assembly are also continuously monitored or polled, as at 43 to determine the active scheduling thereof. However, during an emergency condition the control facilities 10 including the software/computer is operative to override any current displayed scheduling through the generation and display of the aforementioned variable content messaging, in the form of lockdown instructions 33; evacuation mapping/escape route 35; hide and shelter instructions 37; and quarantine instructions 39. Further the ability of the monitoring/polling 43 of the display assembly provides for an automatic “on-mode” capabilities 46. By way of example, if any one of the displays 32, 34 are in an off mode, such displays may be turned on by virtue of the control facilities 20, for purposes of delivering the appropriate variable content messaging, in the form of lockdown instructions, evacuation mapping hide and shelter and quarantine instructions, as described above.

The system of the present invention also includes on-site, off-site communication capabilities 50 as represented in FIG. 1C. More specifically, the control facility 20 enables operation/activation of an off-site communication link 52 allowing various authorities, entities, personnel, etc. such as police department, fire department, hospitals and other type first-responders 54, to link into the control capabilities 20. Such a linked communication 52 is established, at least to the extent of being aware of the one or more detected emergency conditions, as well as providing physical data, such as floor plans 200, of a given facility 300 and/or ingress/egress locations, etc. In turn, this linked communication 52 facilitates establishment or determination of a better approach and response to the detected one or more emergency conditions by saving critical time.

Yet one or more additional preferred embodiments of the system of the present invention includes on-site input capabilities 60, as represented in FIG. 1D. The input capabilities 60 allow at least minimum communicative input from one or more of the facility areas, (rooms, offices, etc.) or other locations throughout the facility 300 with the control capabilities 20. Such input communication from different locations throughout the facility 200 enables confirmation response of the receipt of the variable content messaging (lockdown instructions) and or evacuation mapping (escape routes).

In addition, unusual situations may arise where a new exit is established such as breaking a window to facilitate emergency exiting. Input response 60 from a given facility area to the control capabilities 20 enables automated processing to determine the existence of the new exit (broken window) and the automated establishment of different evacuation mapping in terms of one or more additional escape routes from different ones of the facility areas (rooms) to the newly established exit (broken window).

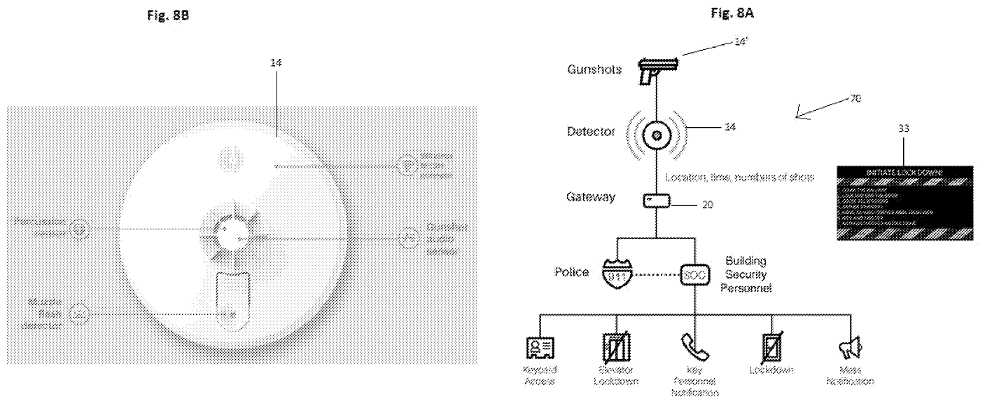

FIGS. 8A and 8B present a schematic representation 70 of an active shooter emergency situation 14′. More specifically, the determination by a sensor 14 of a gunshot 14′ is transmitted to the control capabilities 20 resulting in the generation of variable content messaging such as, but not limited to, lockdown instructions 33. Concurrently, both on-site and off-site first responders will be contacted utilizing various methods of communication, as described above with reference to FIG. 1C. In more specific terms and with reference to FIG. 8B, the sensor/alarm 14 specifically adapted to detect a gunshot 14′ may be operative to detect the sound of the gunshot, the percussion thereof and/or the muzzle flash. Further, the sensor alarm 14 as represented in FIG. 8B is manufactured and produced by AmberBox, Inc. of San Francisco, California.

Therefore, the present invention is directed to a system 100 implemented by software and artificial intelligence to integrate normally disparate emergency response capabilities and provide real-time messaging to various areas within a facility, wherein the messaging comprises variable responsive content such as, but not limited to evacuation mapping and lockdown instructions, dependent on the different emergency conditions detected.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A system for integrating disparate emergency response capabilities within a facility, said system comprising:
a sensor assembly comprising a plurality of sensors disposed in predetermined locations throughout the facility,
different ones of said plurality of sensors determinative of different emergency conditions,
a plurality of displays located in different facility areas;
a software program responsive to said sensor assembly and operative to generate messaging content to said plurality of displays,
at least a plurality of said displays being multi-purpose displays located in different rooms in the facility and structured to provide normal video functionality, including alternate information source content, to the room in addition to receiving said messaging content;
said messaging content comprising variable responsive content, dependent on said different emergency conditions,
said system responsive to one or more of said different emergency conditions upon occurrence thereof and operative to concurrently generate different messaging content to different ones of said facility areas,
at least one of said plurality of sensors operative to detect a first of said one or more different emergency conditions; at least one other of said plurality of sensors operative to detect a second of said one or more different emergency conditions,
said software program further operative to generate said messaging content indicative of said first of said one or more different emergency conditions to at least one facility area and said messaging content indicative of said second of said one or more emergency conditions to at least one other facility area,
said software program further operative to update said messaging content upon a detection of a change in said first or second of said one or more of different emergency conditions or a detection of a development of another of said one or more emergency conditions to messaging content indicative of change in said first or second of said one or more of different emergency conditions or said development of another of said one or more emergency conditions,
said software program further operative to generate said messaging content indicative of said change in said first or second of said one or more of different emergency conditions or said development of another of said one or more emergency conditions to different facility areas,
said software program further operative to generate said messaging content specific to the room in which said display is located, and
said system configured to receive at least one communicative input from at least one of said facility areas, said at least one communicative input comprising a confirmation response of said messaging content.

2. The system as recited in claim 1 wherein said variable responsive content comprises lockdown instructions.

3. The system as recited in claim 2 wherein said variable responsive content comprises evacuation mapping indicative of escape routes from different ones of the rooms in said facility areas to predetermined facility exits.

4. The system as recited in claim 3 wherein said display assembly comprises a plurality of displays variably disposed along said plurality of escape routes.

5. The system as recited in claim 3 wherein said software program is operative to update said variable responsive content to include a change of said lockdown instructions or said escape routes to the other of said lockdown instructions or escape routes.

6. The system as recited in claim 3 wherein said software program is operative to concurrently generate said lockdown instructions to at least one of said facility areas and said evacuation mapping to at least one other of said facility areas, via a corresponding one of said plurality of displays.

7. The system as recited in claim 3 wherein said software program is operative to update said escape routes dependent on current status of said different emergency conditions.

8. The system as recited in claim 7 wherein said escape route updates are changeable on a real-time basis from any one of said facility areas to a different one of said predetermined facility exits.

9. The system as recited in claim 1 further comprising monitoring capabilities operatively associated with said sensor assembly, said monitoring capabilities operative to determine at least one of sensor activity and sensor status.

10. The system as recited in claim 9 wherein said monitoring capabilities are operatively associated with said display assembly; said monitoring capabilities operative to determine at least one of said display activity and display status.

11. The system as recited in claim 1 wherein said display assembly comprises remote capabilities including an auto-on mode upon determination of at least one of said different emergency conditions.

12. The system as recited in claim 11 wherein said remote capabilities further include display of said variable responsive content concurrent to determination of at least one of said different emergency conditions.

13. The system as recited in claim 1 wherein said multi-purpose displays are structured to facilitate two way communication into the room.

14. The system as recited in claim 1 wherein said different emergency conditions include an active-shooter condition and said plurality of sensors include at least one active-shooter sensor structured to be determinative of at least one of percussion detection, gunshot audio detection, and muzzle flash detection.

15. The system as recited in claim 1 further comprising a database associated with said software program and structured for storage of floorplan data of the facility.

16. The method as recited in claim 15 wherein said software program includes vector mapping integrated into said floorplan data; said vector mapping defining escape routes within said facility concurrently generated upon said determination of at least one of said different emergency conditions.

17. The system as recited in claim 16 wherein said vector mapping includes obstruction input integrated said floorplan data associated with different ones of said escape routes.

18. The system as recited in claim 17 wherein said software program is operative to prioritize escape route from said facility areas to said facility exits, said escape route prioritization comprising shortest distance taking into account avoidance of said obstruction input and other sensor inputs.

19. The system as recited in claim 1, wherein said messaging content indicative of said change in said first or second of said one or more of different emergency conditions or said development of another of said one or more emergency conditions to different facility areas comprises alternative evacuation mapping reflective of the existence of at least one newly established exit.

20. The system as recited in claim 19, wherein said at least one newly established exit comprises a broken window.
